(19) United States
(12) Patent Application Publication
(10) Pub. No.: US 2022/0319311 A1
(43) Pub. Date: Oct. 6, 2022

(54) METHOD AND SYSTEM FOR DYNAMIC EVENT IDENTIFICATION AND DISSEMINATION

(71) Applicant: NEC Laboratories Europe GmbH, Heidelberg (DE)

(72) Inventors: Faqir Zarrar YOUSAF, Heidelberg (DE); Xi LI, Heidelberg (DE); Marco LIEBSCH, Heidelberg (DE)

(21) Appl. No.: 17/616,704

(22) PCT Filed: Aug. 15, 2019
(86) PCT No.: PCT/EP2019/071982

§ 371 Date: Dec. 6, 2021

(30) Foreign Application Priority Data
Jun. 7, 2019 (EP) 19178984.1

(51) Int. Cl. G08G 1/01; G08G 1/0967

(52) U.S. Cl. CPC G08G 1/0141; G08G 1/0112; G08G 1/096783

(57) ABSTRACT

A method for real-time and dynamic event-related information derivation and dissemination by a road infrastructure to control, coordinate and consolidate information from one or more observation entities includes receiving, by a road infrastructure server of the road infrastructure, event information from the observation entities. Each of the observation entities provides its event information as an event information frame that comprises an event data record including a number of attributes together with a unique identifier referencing the event data record. The event information frames received from the observation entities are collected and analyzed, and are processed to generate a combined event information frame that includes composite event information, a unique identifier referencing the composite event information, and control commands to coordinate communication with the observation entities. The combined event information frame is distributed within a distribution domain.

### CROSS REFERENCE TO RELATED APPLICATIONS

This application is a U.S. National Phase application under 35 U.S.C. § 371 of International Application No. PCT/EP2019/071982, filed on Aug. 15, 2019, and claims benefit to European Patent Application No. EP 19178984.1, filed on Jun. 7, 2019. The International Application was published in English on Dec. 10, 2020, as WO 2020/244787 A1 under PCT Article 21(2).

### STATEMENT REGARDING SPONSORED RESEARCH OR DEVELOPMENT

The project leading to this application has received funding from the European Union's Horizon 2020 research and innovation programme under grant agreement No 825012.

### FIELD

The present invention relates to road safety, and more particularly, to a method for dynamic event-related information dissemination as well as to a road vehicle onboard system. The invention not only applies to vehicles, but also is applicable to any other observation entities in the form of mobile devices that have required sensing, computing and communication capabilities.

### BACKGROUND

Events like accidents and road-works (or civil works in areas adjoining the roads) may result in traffic congestion causing unexpected delays for the commuters. The duration of such congestions at choke-points may range from a few minutes to hours, days, weeks or months depending on the type of event. For instance, minor accidents may result in road congestion lasting for 10s of minutes while serious accidents may result in congestion that may last for several hours. Similarly, events like regular road maintenance may last for a few days while major construction projects may cause congestion lasting for weeks and months.

Existing automotive systems do not have efficient provisions to warn and/or divert a vehicle away from temporary choke-points on the roads except for radio announcements and relay of vague traffic congestion warning via the navigation system asking the drivers to choose for an alternate route without specifying any reason nor details. Such information is usually untimely and may also be stale by the time when the message is received, and in addition does not include information specifying the reason and the impact the events caused.

With reference to the state-of-art analysis, almost all the methods/systems for vehicular situation awareness rely at some level on the availability of external sensors and soft information systems in addition to limited vehicular objects. Example of external sensors are road-side cameras (with fixed perspective), flow measuring devices, automatic traffic jam detectors, etc., whereas examples of soft information sources are call centers (where drivers call in to inform of prevailing road/traffic conditions), FM radio stations, weather stations, public event information system, traffic management system, road-works information system, etc. Most soft information systems have a “human-factor” that impacts the reliability of developing an accurate event identification and the accuracy of the information, and that incurs delays in disseminating the information. Furthermore, call center solutions are insecure as the drivers report the event via phone, which is illegal and dangerous.

### SUMMARY

In an embodiment, the present disclosure provides a method for real-time and dynamic event-related information derivation and dissemination by a road infrastructure to control, coordinate and consolidate information from one or more observation entities. The method includes receiving, by a road infrastructure server of the road infrastructure, event information from the one or more observation entities. Each of the one or more observation entities provides its event information as an event information frame that comprises an event data record including a number of attributes together with a unique identifier referencing the event data record. The event information frames received from the one or more observation entities are collected and analyzed, and are processed to generate a combined event information frame that includes composite event information, a unique identifier referencing the composite event information, and control commands to coordinate communication with the one or more observation entities. The combined event information frame is distributed within a distribution domain.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view illustrating an overview of a road scenario for deployment of a system for event identification and dissemination in accordance with an embodiment of the invention,

FIG. 2 is a functional overview illustrating a vehicle's on-board unit comprising an event record engine, ERE, in accordance with an embodiment of the invention,

FIG. 3 is a diagram illustrating the sampling and processing of onboard sensor data by the ERE in accordance with an embodiment of the invention,

FIG. 4 is a functional overview illustrating infrastructure servers processing information received from the ERE, and

FIG. 5 is a process overview illustrating infrastructure servers processing information received from the ERE.

### DETAILED DESCRIPTION

Embodiments of the present invention improve and further develop a method for dynamic event-related information dissemination as well as a road vehicle onboard system in such a way that an efficient, fine-granular and effective issuance of in-advance warnings in near real-time to vehicles on road choke-points that may exist on a planned route is enabled.

In accordance with an embodiment of the invention, the enablement of efficient, fine-granular and effective issuance of in-advance warnings in near real-time to vehicles on road choke-points that may exist on a planned route is accomplished by a method for real-time and dynamic event-related information derivation and dissemination by a road infrastructure to control, coordinate and consolidate information from at least one observation entity, the observation entity being preferably an independent vehicle, a mobile device or the like, the method comprising:

receiving, by a road infrastructure server of the road infrastructure, event information from one or multiple observation entities, wherein each of the observation entities provides its event information as an event information frame that comprises an event data record including a number of attributes together with a unique identifier referencing the event data record,

collecting and analyzing the event information frames received from the observation entities and processing them to generate a combined event information frame that includes composite event information, a unique identifier referencing the composite event information, and control commands to coordinate the communication with the observation entities, and

distributing the combined event information frame within a distribution domain.

In another embodiment of the invention, the enablement of efficient, fine-granular and effective issuance of in-advance warnings in near real-time to vehicles on road choke-points that may exist on a planned route is accomplished by a road vehicle onboard system, comprising an onboard unit, OBU, that provides computational and communication capabilities and that is configured:

to receive event-related raw sensor data from a vehicle's onboard sensor system and/or from a smart device carried along by the vehicle's driver,

to process the received raw sensor data and to generate an event-data record that contains attributes in form of contextual event-descriptive information derived from the raw sensor data,

to generate, based on the attributes of the event-data record, a unique identifier referred to as event_signature,

to create an event information frame that contains at least the event_signature and the attributes of the event-data record, and

to transmit the event information frame towards a road infrastructure server.

Embodiments of the present invention provide an efficient method and system for dynamic event identification, dissemination and update. Embodiments of the invention enable a context-based identification and evaluation of road events and a fast and autonomous dissemination of such events by moving objects (e.g., vehicles) in a cooperative way that is centrally coordinated by infrastructure servers.

In contrast to prior solutions, the method and system according to embodiments of the invention are independent of reliance on any external sensors and/or soft information systems (i.e., infrastructure-less) and basically rely on leveraging the on-board sensor cluster available on the target object (i.e., vehicle), and can also include the smartphone carried by the driver/passengers as it offers its own ecosystem of sensors. Embodiments of the invention also rely on the all-pervasive mobile network infrastructure to accurately identify and determine the event and disseminate it in near-real time. Thus, the scope of embodiments of the invention also applies to any road network and not just highways. The main dependence is on the availability of a mobile network infrastructure. Moreover, embodiments of the invention factor out any human intervention (zero touch), thus allowing more precise, consistent and fine granular event identification and dissemination (to other vehicles or to first responders in case of accidents) by leveraging on information generated by independent mobile objects (i.e., vehicles). As such, embodiments of the invention are also suited to autonomous (self-driving) cars.

In contrast, prior art approaches appear to not have a central coordination of collecting the information from multiple vehicles on the road. They send their context information to the infrastructure server independently and periodically. However, this causes the problem of periodically sending duplicated information reporting the same event by the same car as well as by multiple cars in the area, which wastes the network resources (especially on uplink) unnecessarily which may result in network congestion and overload, while incurring high processing load and long delays for other mobile data communications.

Embodiments of the present invention leverage on the vehicles' on-board sensors and computational capabilities (on-board compute resources) to derive a unique identifier (event-signature) for the event and explore the V2X communications in collaboration with the road infrastructure servers to identify and analyze the event and its severity, and disseminate this information in a variety of ways, such as notifications to first-responders in near-real-time and/or dynamic update of navigation maps and route plans to a specific range of area where the events causing choke points on the road. The challenge is to enable the timely and accurate acquisition of event information and its dissemination to vehicles in a cost effective manner consuming minimum processing and radio resources.

According to embodiments, the present invention relates to a method at an infrastructure server to control, coordinate and consolidate the information from one or multiple independent vehicles or other observation entities. This may include identification and clustering of event information from multiple sources, i.e. vehicles, and generating a combined event identifier along with a set of selected attributes and control flags to command the vehicles to send relevant updated information if necessary. Moreover, this may include consolidating the collected event information from multiple independent vehicles for joint analysis to provide a high granular and more complete and accurate information updates.

According to embodiments, the vehicles and/or other observation entities may provide/notify information regarding their observation/recording of an event in the form of an event information frame. The road infrastructure servers may collect and analyze the event information frames received from vehicles and/or other observation entities and process them to generate a composite information snapshot that may be encoded in a special frame (i.e., the combined event information frame). The distribution of the combined event information frame within a distribution domain may be realized via broadcast, multicast, anycast or unicast transmissions. The size of the distribution domain may be determined by the overall impact that can be derived from an event impact factor and/or delay factor of the respective event.

According to embodiments, the unique identifier included in the event information frame may be an event_signature derived from selected attributes of the event data record, such as by applying a hash algorithm. Alternatively, the identifier may be an unambiguous number derived from the respective vehicle, e.g. including a sequence number and a vehicle identifier, etc. Similarly, the unique identifier included in the combined event information frame may be a combined event_signature derived from the composite event information, such as by applying a hash algorithm.

According to embodiments, the present invention relates to a car onboard system, such as an OBU with sensors like camera, light, accelerator, etc., a processor, memories, and networking interfaces. The onboard system may include an image recognition application that may be used to identify an event, road signs and also decipher any textual information that may be stated on the road sign. The infrastructure computation enables to harmonize the event information from OBUs from different manufacturers with different image/text recognition application.

According to embodiments, a method may be performed inside the vehicles that identifies and processes (including filtering, classification and/or analysis) the raw data collected from on-board sensors (like cameras, GPS, speed, communication modules, radar, LIDAR etc.), to derive a local unique event identifier with a set of sensible event-data (e.g. event type, impact_factor, estimated event duration, delay_factor, etc.) including images/video data. The vehicles may be configured to send this information—contained within an event information frame—to an infrastructure server.

According to embodiments, the vehicles may be further configured to decode a “combined-event-information-frame” sent from the infrastructure server to identify the relevance of the indicated events to the vehicle and to execute requested actions. The respective actions may be indicated by the infrastructure server within the “combined-event-information-frame” by setting or activating respective control flags. For instance, a “SEND_MORE” flag may request the vehicle to send more event-related information to the infrastructure server, and a “UPDATE” flag may notify the vehicle that the “combined-event-information-frame” contains updated information.

According to embodiments, the infrastructure servers may include one or more MEC servers and/or a core server. Specifically, the infrastructure servers may be configured to perform a mechanism for duplicate event detection processing to identify the cluster of vehicles reporting the same event situation, as well as for combining the event information of this cluster of vehicles, e.g. by applying a convolution function. Additionally, the infrastructure servers may be configured to evaluate the attributes and/or the images (if applied) based on the input from this cluster of vehicles to determine the accuracy of the event information.

Embodiments of the invention aim to prevent vehicles to send duplicated information unnecessarily with the information coordination and identification by the infrastructure server, and without relying on external static information systems. Besides, the context information sent by multiple independent vehicles can be jointly analyzed (e.g. with graph AI or ML techniques, or signal/image processing) at the infrastructure server to provide a high granular and more complete information, which is then disseminated to relevant vehicles and/or stakeholders (e.g. emergency responders).

According to embodiments, as part of an information coordination task, the infrastructure server may be configured to command the vehicles to send more related information, if needed, to develop more accurate event information. By preventing sending duplicate information results in savings of network resources (especially on uplink), which may otherwise result in network congestion and overload thereby causing delay on disseminating event information, as well in reducing superfluous processing load on the backend servers processing the information which is sent upstream from vehicles.

Embodiments of the present invention leverage on the onboard sensors in a vehicle, such as the camera(s), GPS, monitor, communication modules, radar, LIDAR, etc., on the one hand and on a mobile network infrastructure on the other hand. The mobile network infrastructure may be controlled, coordinated and managed by one or more infrastructure servers (e.g., multi-access edge computing, MEC, servers) to enable quick, low-cost, dynamic and accurate event identification and dissemination to road users, i.e. vehicles, and to other stakeholders (e.g., emergency responders) to warn about events and event locations providing real-time event information with pin-point accuracy. The event locations are points on the route that may cause traffic delays and can be characterized by events such as congestion, road-works, accidents, etc. Recipients receiving such warning can then exploit the received information in different ways, e.g., by recalculating routes enabling the vehicles to circumnavigate the event locations (e.g., choke points). The process is enabled with a minimum consumption of compute and radio resources while still remaining scalable.

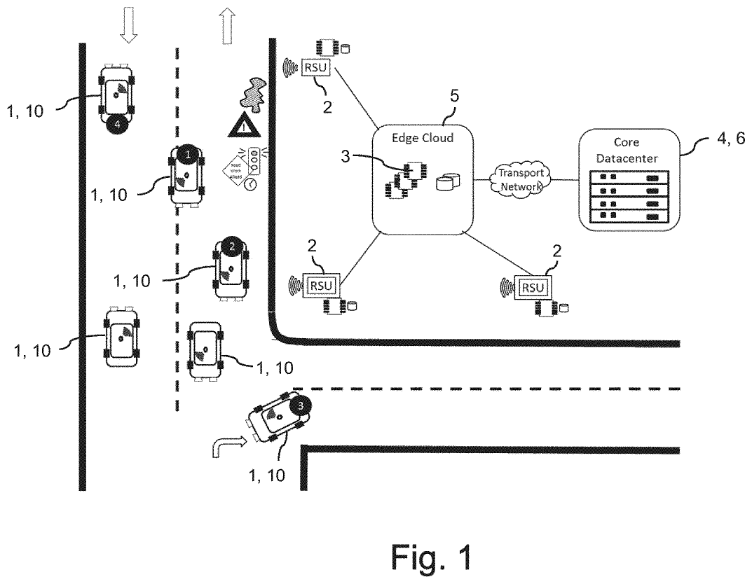

FIG. 1 schematically illustrates a road scenario together with an event identification dissemination system in accordance with an embodiment of the present invention that leverages processing/computing capabilities of both the vehicles 1 and the infrastructure. According to the illustrated embodiment the infrastructure comprises a number of road-side units (RSUs) 2, edge servers (ES) 3 and a core server 4.

A RSU 2 is a communication device, such as Radio Base Station, that is used for communicating information with observation entities 10, i.e. in particular with the vehicles 1, but also with mobile devices or the like. To this end, RSUs 2 are deployed along the roadside. For example, a RSU 2 can be installed at a traffic light or at a cellular radio base station.

The edge-servers (ES) 3 are computing platforms that are located either at a central location, such as an edge cloud datacenter 5, or they may be distributed and collocated with the RSUs 2, e.g. at traffic lights, etc. According to an embodiment of the edge-servers 3 may be implemented in form of MEC (multi-access edge computing) servers in an edge cloud infrastructure. The core servers (CS) 4 may be implemented in a core data center 6.

According to the embodiment illustrated in connection with the scenario of FIG. 1, the ESs 3 are assumed to be located in the edge cloud datacenter 5. The RSUs 2 are connected to ES 3 in an N:1 fashion, whereas the ESs 3 are connected to a CS 4 implemented in the core datacenter 6 in a N:1 fashion. The vehicles 1 on the other hand are expected to be equipped with on-board units (OBUs) providing computational and communication capabilities. FIG. 1 shows a reference scenario and the infrastructure layout where vehicles 1 are connected to the RSUs 2 for communication and data access purposes.

Specifically, FIG. 1 illustrates a two-way highway with a choke point located in the right lane. The choke point depicted is due to some event such as a road construction. The event location is characterized by the presence of warning lights, warning signs and a road sign with textual information about the event and necessary information such as the speed-limit in the event-zone, expected time duration of the event and other warnings or diversion information.

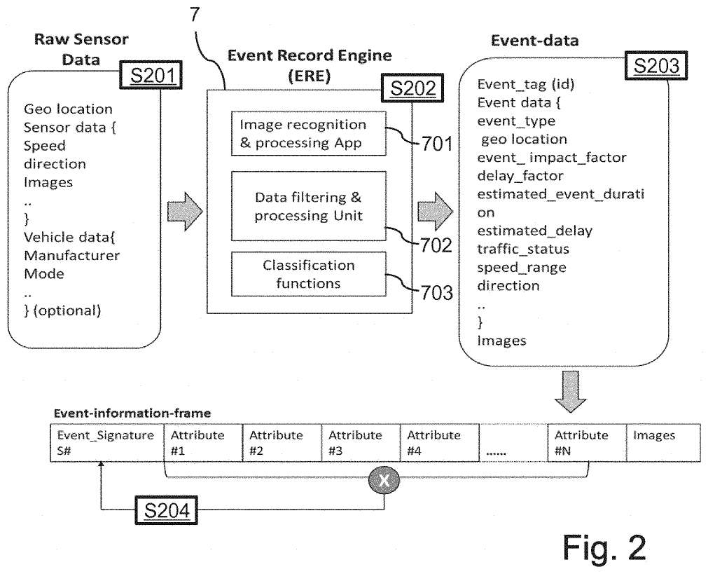

FIG. 2 illustrates a functional overview of the one-board units, OBUs, of the vehicles 1 depicted in the scenario of FIG. 1. According to the illustrated embodiment the OBU comprises a processing unit, hereinafter sometimes denoted Event Record Engine (ERE) 7, which is generally configured to sample and process on-board raw sensor data to derive an event-data record that is then used to derive a unique event_signature, as will be described in detail below. The unique event_signature may then be transmitted towards an infrastructure server, such as the edge server 3 shown in FIG. 1.

According to some embodiments event data processing by a vehicle 1 may be triggered when the vehicle 1 detects an event based on the processing of the output of the vehicle's 1 onboard sensors, e.g. camera images that the vehicle 1 has captured of the event. The vehicle's 1 onboard sensor system may be triggered to take images and send them for processing to the on-board unit (OBU), as depicted in step S201 of FIG. 2. For instance, one trigger event could be when the vehicle's 1 speed significantly drops below the allowed speed limit implying a congested situation or an abrupt brake action implying an accident immediately ahead of the vehicle 1. Upon such a trigger, the OBU solicits the on-board sensors to start sampling for providing/inputting the captured raw data to the Event Record Engine (ERE) 7, which may be part of the vehicle's 1 OBU.

According to the exemplary functional overview in FIG. 2, the ERE 7 comprises the necessary functions to filter, process and classify raw sensor data including the images from the on-board cameras, as indicated at step S202. Specifically, according to the illustrated embodiment the ERE 7 comprises an image/text recognition and processing application 701, a data filtering and processing unit 702 and classification functions 703.

The output of the ERE 7, as provided in step S203, is an Event-data record that contains processed contextual data derived from the raw-data as part of the ERE 7 processing. For instance, from the images received from the vehicle's 1 on-board cameras, the image/text recognition and processing application 701, which is part of the ERE 7, may identify event related information, e.g. by deciphering any textual information that may be stated on road signs to create a more clear event context. Based on the evaluated event context, the ERE 7 may specify the type of the event (which may be recorded as event_type). Moreover, relevant temporal information received from the various sensors of the vehicle 1 can be jointly processed to derive information on a potential impact of the identified event. For instance, this information may be recorded as an event impact factor.

Table 1 below provides an example embodiment of an Event-data record with a non-exhaustive list of event-data together with the respective definition.

TABLE 1
A map of event_signature and event_data managed by the OBU

| Key | Value [event_data] | Comments |
|---|---|---|
| event_ | event_tag | An enum value that would indicate the type |
| sig- | | of event. For example, road works, accident, |
| nature | | ice on road, fire, unspecified, etc. |
| | event_geo_ | Geo-location of event derived from the GPS |
| | location | coordinates of the observing vehicle. |
| | | According to embodiments the resolution of |
| | | the GPS coordinates is kept coarse-grained |
| | | in order to prevent against the derivation of |
| | | a different event signature (e.g. different |
| | | hash) for each periodic observation. |
| | event_impact_ | An enum value indicative of the impact of |
| | factor | event. For example, mild, serious, critical. |
| | delay_factor | An enum value indicative of the impact of |
| | | event on the time it takes to bypass the |
| | | event. For example, short-term, medium- |
| | | term, long-term. |
| | estimated_ | An integer value indicative of the estimated |
| | event_ | time, in minutes hours or days, of the event |
| | duration | to last. |
| | estimated_ | An integer value indicating the time, in |
| | delay | minutes, needed to overtake the event |
| | | location. |
| | traffic_state | An enum indicating the state of surrounding |
| | | traffic, to prevent against false triggers |
| | | to the OBU. |
| | speed_range | The range of the speed of the observing |
| | | vehicle. For example, 10-30 kph, 30-50 |
| | | kph, 50-70 kph. The range acts as a filter |
| | | to prevent against the derivation of a |
| | | different hash for each periodic observation. |
| | direction | The direction of the observing vehicle with |
| | | respect to the observed event i.e., towards; |
| | | away. In case the vehicle is in a different |
| | | lane from that of the event, and not affected |
| | | by the event, then the map may not be |
| | | required to be updated. |
| | vehicle_make | An enum value providing information on |
| | | vehicle manufacturer. |
| | vehicle_type | Type of vehicle e.g., car, truck, bus, |
| | | motorbike. The map update may be |
| | | different for different types of vehicles. |

According to embodiments the ERE 7, based on the Event-data record, creates a unique event_signature that is construed as a unique identifier referencing the event-data record. The event_signature can be derived from the Event-data record by one of several well-known methods, such as hash algorithms. According to embodiments, the granularity of Event-data specified in Table 1 above, like for instance event_geo_location and speed range, is kept coarse (i.e., above a configurable granularity threshold) in order ensure the ERE 7 to be generating the same event_signature independent of slight changes (i.e., below the granularity threshold) in distance and/or speed.

The ERE 7, after having created the event_signature, will create an “event_Information_frame”, as shown in step S204 of FIG. 2. This “event_Information_frame” consists of the event_signature, the attributes of the Event-data record from which the event_signature is created and a set of images and/or videos that the cameras of vehicle's 1 on-board sensor system took of the event. The event_Information_frame is then transmitted towards a RSU 2 (e.g., mobile BS) that can relay it to an associated ES 3, such as MEC server.

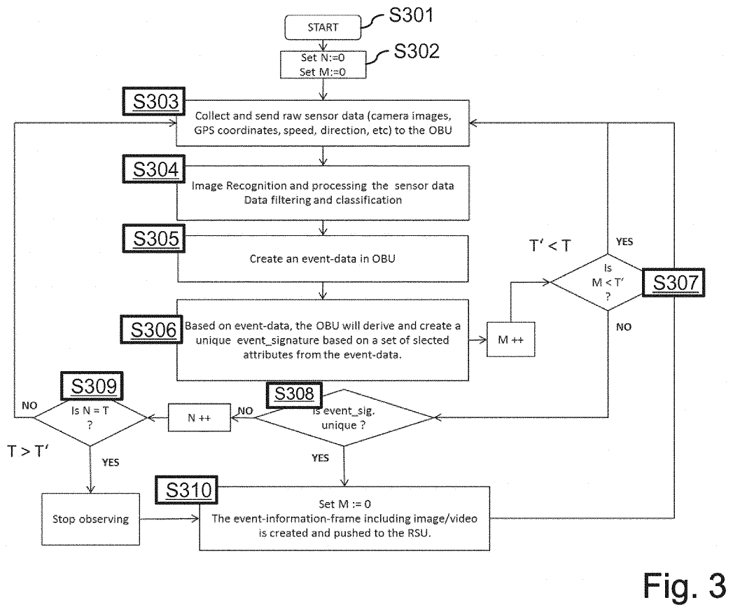

FIG. 3 is a diagram showing a detailed process logic of the ERE 7 sampling and processing on-board sensor data according to an embodiment of the invention. Generally, a decision logic may be included into the process to limit the number of sampling rounds and to ensure that the derived event_signature for multiple rounds is unique, afterwards which the vehicle 1 will send the event_Informaion_frame via a RSU 2 to an associated ES 3. Hereinafter, the process will be described in greater detail.

The process starts at S301 by first initializing two counters N and M, by setting N:=0 and by setting M:=0, as shown at S302. At S303, the vehicle's 1 OBU receives raw sensor data (such as camera images and/or videos, GPS coordinates, speed and direction information, etc.) collected by the vehicle's 1 on-board sensor system. Basically, this step corresponds to step S201 of FIG. 2.

Next, at S304, dedicated applications of the ERE 7 perform image recognition and processing of the sensor data, as well as data filtering and classification. Basically, this step corresponds to step S202 of FIG. 2.

At S305, the ERE 7, based on the outcome of the data analysis performed in the previous step, generates an event-data (corresponding to step S203 of FIG. 2). Based on this event-data, at S306, the vehicle's 1 OBU derives and creates a unique event_signature (denoted event_signature) based on a set of selected attributes from the event-data (corresponding to step S204 of FIG. 2).

According to the illustrated embodiment the process defines two threshold, namely T and T′, such that T>T′. The threshold T′ is intended to govern the number of sampling rounds to collect and sample data from on-board sensors. On the other hand, this threshold T is intended to govern the number of times the process is repeated to ensure the uniqueness of the derived event_signature.

More specifically, as shown at S307, the ERE 7 will sample and process raw data T′ number of times to derive event_signature and ensure that it is unique. In case the event_signature uniqueness test (as performed at S308) fails, then the same process will be repeated T times (S309). After a unique event_signature has been derived from the Event-data record, an event-information-frame will be generated as described above with reference to FIG. 2 and sent towards the ES 3 via the RSU 2 (as shown at S310). In case that after T repetitions, a unique event_signature has not been derived, then it may be provided that the ERE 7 stops processing and sends the last Event-data record and the event_signature derived form that Event-data in the event-information-frame to the ES 3 via the RSU 2.

It should be noted that the sampling rate of the on-board sensor data may also be controlled by the infrastructure in case the ES 3 requires the vehicle 1 to send more samples of event-data in order to create a high granular perspective of the event, as will be explained later.

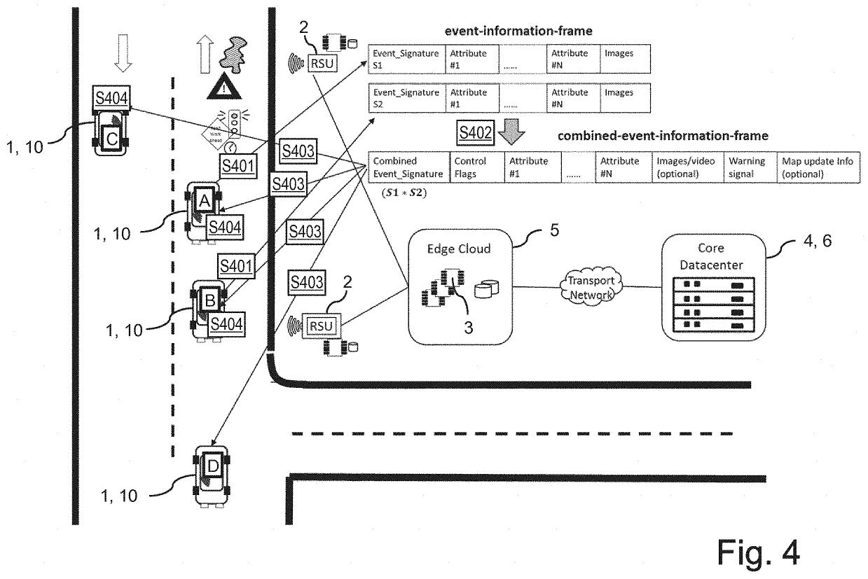

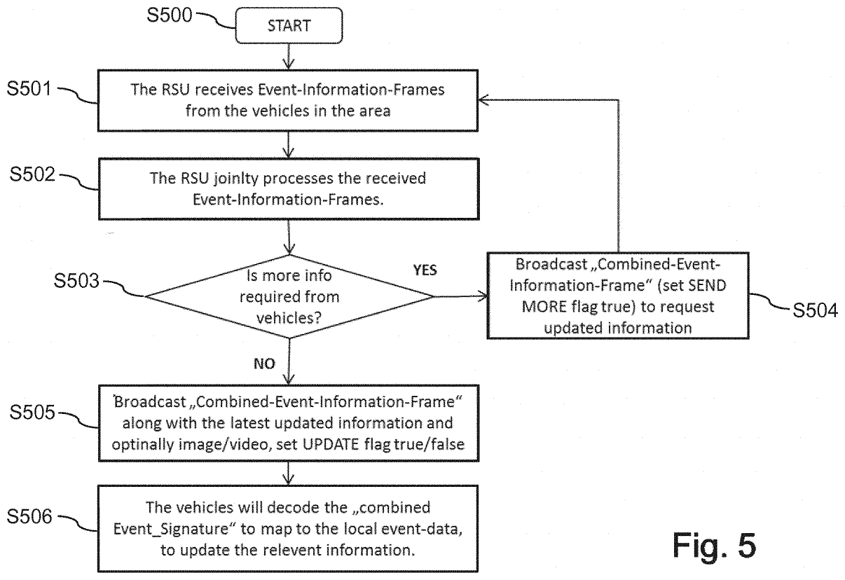

FIGS. 4 and 5 illustrate an embodiment of the above-described method from the infrastructure perspective, i.e. from the perspective of the RSUs 2, the ESs 3 and the CS 4. Specifically, while FIG. 4 shows the functional overview of infrastructure server processing information from the ERE 7, FIG. 5 illustrates the process overview of the processing of information received from the ERE 7 at the infrastructure servers. FIG. 4 depicts a total of four observation entities 10, namely vehicles 1 labeled ‘A’, ‘B’, ‘C’ and ‘D’.

With reference to FIG. 4, at step S401, each of the two vehicles 1 labeled ‘A’ and ‘B’ creates an event-information-frame (as described above in connection with FIGS. 2 and 3) and transmits this frame towards a RSU 2. A RSU 2 that receives such event-information-frame sends it to the processing logic implemented either on the RSU 2 itself or on some dedicated infrastructure server, either at the edge (i.e., ES 3) and/or at the core (i.e., CS 4). Assuming that the processing logic is implemented within an ES 3, such as MEC server, this server may group the event-information-frames received from vehicles 1 within the same location/area, which can be identified using the event geo location parameter inside the event-information-frame.

As shown at step S402, the infrastructure server may then jointly process the information received within the event-information-frames from vehicles 1 labeled ‘A’ and ‘B’ to create a high quality/granular event perspective. As part of this process, the infrastructure server may combine the event_signature from multiple event-information-frames to derive a combined event_signature (denoted combined_event_signature). The combining may be performed by using some coding technique or by convolution of the multiple event-signatures. For example, with reference to FIG. 4, the combined_event_signature (S) may be formed by combining event_signature S1 and S2 from the vehicles 1 labeled ‘A’ and ‘B’. The reason for generating a combined_event_signature is because the output of the image/text recognition application 701 of the ERE 7 may vary from different vehicle manufacturers, which may be indicated by the vehicle_type as contained in Table 1 above. Thus, provided that a plurality of vehicles 1 report their event-data record and their derived event_signature to the infrastructure server, it is possible to create a holistic and accurate event description.

According to an embodiment, the combined_event_signature (S) may be embedded in a Combined-Event-Information-Frame along with control_flags, such as a SEND_MORE flag and/or an UPDATE flag, as well as the attributes from the constituent event-information-frames. Optionally, the image/video information, the warning message, and/or the map update information can also be embedded in the Combined-Event-Information-frame. A generic format of a Combined-Event-Information-Frame according to an embodiment of the invention is shown in FIG. 4.

As shown at step S403, after having processed the event-information from multiple sources as described above, the infrastructure server will broadcast the generated Combined-Event-Information-Frame with updated information. A decoder inside the vehicle's 1 OBUs will decode the combined-event-signature (S) to extract the constituent event_signatures (i.e., S1 and S2 in the described scenario) and store the updated information elements along with the individual event_signatures in an internal Event-database (EDB) which will be mapped to the combined-event-signature. This database may then be used by subsequent vehicles 1 approaching the event location to decide whether or not to send information to the infrastructure, as will be described later. An example embodiment of the EDB after it has been updated by the Combined_Event_Information-Frame is shown in Table 2 below. Since it is based on broadcasted information, all the vehicles 1 receiving the Combined_Event_Information_Frame will have the same entries.

TABLE 2
Example of an Event Database (EDB) maintained inside the vehicles
Event Database (EDB)

| | | |
|---|---|---|
| S | S1 | Updated Event Data Record |
| | S2 | |

As shown in FIG. 4, the vehicle 1 labeled ‘D’, which has not yet arrived at the event location, will also receive this broadcast information and its EDB will be updated as depicted in Table 2 above. When the vehicle 1 labeled ‘D’ arrives at the event location, the event identification process will be triggered as described above. However, the vehicle ‘D’ will check its internal EDB to determine if the same event that it its observing has been reported before or not by proceeding vehicles 1.

There are many indications in the EDB that vehicle ‘D’ can use to determine if the event has been previously reported or if it is a new event. For instance, according to an embodiment it can compare its own event_signature internally derived for the event with those already stored in its EDB. In case vehicle ‘D’ derives Si as an event_signature, then it will know that the event has already been reported and processed, as indicated by S, and that it has an updated Event Data Record. In that case, vehicle ‘D’ will stop the process and will not report it to the infrastructure server. Alternatively or additionally, the geo location information in the Updated Event Data Record will enable vehicle ‘D’ to decide whether to trigger the event identification process or not.

According to embodiments, the same process can be used to report when an event has been resolved, which can then be broadcasted to vehicles 1 to clear the particular Event Data Record from their respective EDB. This method will therefore reduce the duplication of event reports and on-air traffic load, thus reducing consumption of infrastructure including computing, networking and radio resources.

Moreover, the impact_factor and the delay_factor (as specified in Table 1 above) that is derived by the infrastructure server can also enable the infrastructure server to determine the size of the braodcast domain. For instance, in case of events with high impact_factor and with high delay_factor (i.e. above configurable thresholds), the infrastructure server may be configured to broadcast such an event information to a wider geographical area.

With reference to the process summary described above, FIG. 5 illustrates a process logic from the perspective of the servers in the infrastructure in accordance with an embodiment of the invention. After the start at S500, the RSU 2 receives from the vehicles 1 within the RSU's 2 coverage area the Event_Information-Frames carrying the event_signature, event_data, and the camera images on the basis of which the event_signature was derived, as shown at 5501.

Next, as shown at 5502, the RSU 2 processes this data locally, or send it to a remote processing sever e.g., ES 3 to (re-)analyze the event_signature based on the event_data derived by the reporting vehicle 1. More specifically, the RSU 2 or ES 3 may be configured to validate and analyze the data and/or images received from multiple vehicles 1 in the area for the same event. For instance, at a crossing there may be several cars taking images of the crossing from different angles. According to some embodiments, graph AI techniques may be applied to analyze the images so as to (1) identify whether the event information is duplicate or still up-to-date, and (2) to process multiple images jointly to provide more accurate information of the event. A decision of whether more information is required from the vehicles 1 is made at S503.

If the ES 3 (or CS 4) requires more information from the vehicles 1, e.g. in order to create a more accurate identification of an event, it will broadcast the Combined-Event-Information-Frame with the control flag SEND_MORE flag set to TRUE, as shown at S504. The vehicles 1 recognizing the message will send more information following the process explained above with reference to FIGS. 2 and 3. This will continue until the ES 3 (or CS 4) determines that no more information is required, and that the event has been accurately identified and processed. In this case, the process will proceed to step S505.

At S505, the processing infrastructure servers, i.e. either the ES 3 or CS 4, broadcast the final Combined-Event-Information-Frame via the RSUs 2 with the updated information. In case the Combined-Event-Information-Frame contains updated information from that received in the Event-Information-Frame, a control flag within the Combined-Event-Information-Frame referred to as UPDATE flag may be set to TRUE.

According to embodiments the Combined-Event-Information-Frame may also optionally carry updated images of the event, e.g., a 3D-image of the event formed after combining images from different reporting vehicles 1. It may also optionally carry suitable warning signals and/or map updates appropriate to the type of event. For instance, suitable warnings may be derived by the infrastructure servers depending on the event_impact_factor, delay_factor, estimated_event_duration, estimated_delay and traffic_state (as defined in the above Table 1). Based on the received information a vehicle's 1 local navigation system may recalculate the route. According to embodiments, the respective processing server may also suggest a new route plan to bypass/avoid the event. As a result, these embodiments enable a dynamic update of maps and/or route plans with reduced uplink traffic thereby saving on radio resources and compute resources at the infrastructure servers.

Depending on the relevance and/or severity of the event, it may be provided that the processing server, in case of events with a high impact_factor and delay_factor, i.e., above configurable thresholds, relay the map updates to a central server, e.g. CS 4. This will enable the central server to make map updates and push them towards all RSUs 2. The map updates when broadcasted may also include the event_signature that is stored in the EDB of the receiving vehicles 1. This is done to ensure against unnecessary reporting of events that have already been reported by earlier vehicles 1, as described above.

Finally, as shown at step S506, upon reception of the Combined-Event-Information-Frame by a vehicle 1, the OBU will decode the “Combined-Event-Signature” to map to the local event-data, and to update the relevant information in the vehicle's 1 EDB, as described above.

It should be noted that the processing of vehicular information within the infrastructure is done either at the RSUs 2, provided they have the processing capabilities, or it is relayed to an ES 3 inside the edge datacenter 5. The ES 3 will then relay the processed information (i.e., the event_signature) to the vehicles 1 via the RSUs 2 that are associated to it. The decision to further relay this information to the CS 4 inside the core datacenter 6 may be taken depending on the level of permanence determined from the values of the parameters event_impact_factor, delay_factor, estimated_event_duration. For example, high impact events of long duration may be relayed to the CS 4 so that the map updates can be broadcasted to vehicles 1 in a much larger region for future route calculations. In other words, the derivation of the event impact factor allows for the decision on the scope of dissemination of map updates.

After the maps are updated with choke-points pinned on the maps, then the next time when a vehicle 1 approaches any of the choke points, a trigger will be sent to the vehicle's 1 OBU to solicit the sensors for information. In case the event has been resolved and the traffic flow is normal, then a different event_signature (e.g. a different hash) will be computed than the previous one with an indication of the resolution of the previously reported event. This may then be sent to and processed by the ES/CS 3, 4 in a similar manner as depicted in FIGS. 2 and 4. As a result, the maps may be re-updated and the respective choke-point pin can be removed. Accordingly, it is an advantage of embodiments of the invention that the same process can be used to notify the updates in case the event is over and the choke point resolved.

According to embodiments, along with the downstream notification (i.e. infrastructure to vehicles 1) of an event_signature and the attributes/values, which comprise event-descriptive information per the associated event data record, the infrastructure nodes (i.e. ES 3, CS 4) may be configured to provide additional control information to the vehicles 1. This control information may determine on the one hand how vehicles 1 should treat continuously or additionally captured information associated with a known event (i.e., whether or not to send such information upstream to the infrastructure), as well as how to treat distributed information sent downstream from the infrastructure to the vehicles 1.

Regarding control information associated with the treatment of captured information at vehicles1, it may be provided that the infrastructure servers are capable of requesting a vehicle 1 to continue sending additional data associated with a known event (i.e. the vehicle 1 has an entry of the event_signature already in its event_signature database) upstream towards the infrastructure. This mechanism enables the infrastructure to build a more accurate description of the event and situation. For example, additional camera pictures from different vehicles 1 taken from different angles allow the infrastructure creating a 3D- or rotating image of the situation. In this context it may be provided that the event is visualized from the perspective of a particular vehicle 1 according to its direction from which it approaches the location associated with the event. Also, multiple samples of a delay factor from multiple vehicles 1 allow the infrastructure to build a more accurate average or updated value, or to build a delay factor in dependency of the direction from which a vehicle 1 approaches the location associated with the event. A request for such control information may be indicated by the control tag “SEND_MORE” in the message Combined-Event-Information-Frame sent from the infrastructure nodes (ES 3, CS 4) to the vehicles 1.

Regarding control information associated with the processing of received downstream information from the infrastructure, it may be provided that the infrastructure indicates to the vehicles 1 to not only lookup and match the event_signature with entries in its local event_signature_database, but to process the attached attributes/values. The reason for this may be that, e.g., updated information is included, for example a more accurate event situation description, changes in the described situation, etc. Such control information may be indicated by the control tag “UPDATE” in the message Combined-Event-Information-Frame sent from the infrastructure nodes (ES 3, CS 4) to the vehicles 1.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for real-time and dynamic event-related information derivation and dissemination by a road infrastructure to control, coordinate and consolidate information from one or more observation entities, the method comprising:
receiving, by a road infrastructure server of the road infrastructure, event information from the one or more observation entities, wherein each of the one or more observation entities provides its event information as an event information frame that comprises an event data record including a number of attributes together with a unique identifier referencing the event data record,
collecting and analyzing the event information frames received from the one or more observation entities and processing the event information frames to generate a combined event information frame that includes composite event information, a unique identifier referencing the composite event information, and control commands to coordinate communication with the one or more observation entities, and
distributing the combined event information frame within a distribution domain.

2. The method according to claim 1, wherein the unique identifier included in the event information frame is an event signature derived from selected ones of the attributes of the event data record, and/or wherein the unique identifier included in the combined event information frame is a combined event signature derived from the composite event information.

3. The method according to claim 1, wherein the combined event information frame is sent from the infrastructure server to the one or more observation entities and contains one or more control flags, wherein one of the control flags, when being set or activated, instructs the one or more observation entities to send additional data associated with an event.

4. The method according to claim 1, wherein the combined event information frame is sent from the infrastructure server to the one or more observation entities and contains one or more control flags, wherein one of the control flags, when being set or activated, informs the one or more observation entities that the combined event information frame contains updated information associated with an event which can be processed and updated locally by the one or more observation entities.

5. The method according to claim 1, wherein the infrastructure server integrates adapted warning signals and/or map updates into the combined event information frame based on one or more attributes contained in the combined event information frame.

6. The method according to claim 1, wherein the infrastructure server determines a size of the distribution domain based on attributes indicative of an impact and/or a delay associated with an event.

7. The method according to claim 1, wherein the infrastructure server is implemented at a road-side unit (RSU), or at an edge server, or in a core data center.

8. A road vehicle onboard system, comprising:
an onboard unit (OBU) having, computational and communication capabilities, the OBU being configured to:
receive event-related raw sensor data from an onboard sensor system of the vehicle and/or from a smart device carried along by the vehicle,
process the received raw sensor data and to-generate an event-data record that contains attributes in a form of contextual event-descriptive information derived from the raw sensor data,
generate, based on the attributes of the event-data record, a unique identifier as an event signature,
create an event information frame that contains at least the event signature and the attributes of the event-data record, and
transmit the event information frame towards a road infrastructure server.

9. The system according to claim 8, wherein the OBU comprises an event record engine including an image/text recognition application that is configured to:
process images taken by cameras of the onboard sensor system, and
create contextual event data by deciphering textual information that is stated on road signs identified within the images.

10. The system according to claim 8, wherein the OBU is configured, upon detection of a trigger event, to request the onboard sensor system to take data and to provide the data for processing to the OBU, and wherein the trigger event includes an abrupt brake action of the vehicle and/or a situation in which a speed of the vehicle drops below an allowed speed limit to a configurable extent.

11. The system according to claim 8, wherein the OBU comprises an event record engine that is configured to sample and process the raw sensor data T′ number of times to ensure that the event signature derived from the attributes of the event-data record is unique, and wherein T′ is a configurable threshold.

12. The system according to claim 8, wherein the event-data record contains an event type attribute that indicates an identified type of the event, and/or an event geo-location attribute that indicates an identified location of the event.

13. The system according to 8, wherein the OBU is configured to receive a combined event information frame from an infrastructure server and to decode the combined event signature.

14. The system according to claim 13, wherein the OBU is configured to use the decoded combined event signature to decide whether to trigger an event identification process.

15. The system according to claim 8, wherein the onboard sensor system includes one or more cameras, a global positioning system (GPS) module, a monitor, a communication module, a radar module, and/or a light detection and ranging (LIDAR) module.

16. The method according to claim 1, wherein the one or more observation entities include one or more vehicles or mobile devices.

17. The method according to claim 2, wherein the event signature and/or the combined event signature is derived by applying a hash function.
